(19) United States
(12) Patent Application Publication
(10) Pub. No.: US 2025/0165744 A1
(43) Pub. Date: May 22, 2025

(54) METHOD AND SYSTEM FOR INTEGRATED MULTIMODAL INPUT PROCESSING FOR VIRTUAL AGENTS

(71) Applicant: Quantiphi, Inc., Marlborough, MA (US)

(72) Inventors: Dagnachew Birru, Marlborough, MA (US); Saisubramaniam Gopalakrishnan, Mumbai (IN); Siva Prasad Sompalli, Mumbai (IN); Varun V, Mumbai (IN); Vishal Vaddina, Toronto (CA)

(21) Appl. No.: 18/511,796

(22) Filed: Nov. 16, 2023

(51) Int. Cl. G06N 3/006

(52) U.S. Cl. CPC G06N 3/006

(57) ABSTRACT

A method and system for multimodal input processing for a virtual agent is provided herein. The method comprises obtaining a multimodal input by the virtual agent from a user. The method further comprises identifying a plurality of principal entities within the multimodal input. The method further comprises extracting information about each entity of the plurality of principal entities. Further, the method comprises generating a response based on the extracted information.

### TECHNICAL FIELD OF THE INVENTION

The present disclosure is related to multimodal interactions, and more particularly to a method and a system for multimodal input processing for a virtual agent using Artificial Intelligence (AI) models.

### BACKGROUND OF THE INVENTION

In today's digital age, virtual agents and AI-powered systems have become increasingly integrated into our daily lives. These virtual agents are designed to understand and respond to user inputs, making them valuable tools for a wide range of applications, from customer service chatbots to virtual assistants in smart devices.

Traditionally, virtual agents and chatbots have relied heavily on text-based inputs and rule-based systems. These systems use predefined decision trees and scripts to generate responses to user queries. While they have been effective for simple tasks like information retrieval or basic customer support, they have significant limitations when it comes to handling more complex, natural language interactions.

With the advent of AI and Natural Language Processing (NLP), some advancements have been made in virtual agent technology. Large Language Models (LLMs), such as GPT-3 and GPT-4, have demonstrated impressive capabilities in understanding and generating human-like text. These models have been integrated into virtual agents, allowing them to provide more contextually relevant responses to text-based queries.

However, these existing techniques primarily focus on text-based interactions, and their ability to handle other modalities like speech, sensor data, or visual inputs is limited. Furthermore, they often lack the ability to understand user emotions and adapt their responses accordingly. These limitations result in less engaging and less effective user-agent interactions.

Therefore, in order to overcome the aforementioned problems, there exists a need for techniques that effectively process multimodal inputs for the virtual agent. To achieve this, the proposed techniques employ a Generative AI model, providing a multimodal approach that understands various data inputs, adapts to user preferences and emotions, and continuously improves its responses over time, offering users a more satisfying and engaging experience.

It is within this context that the present embodiments arise.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a method for multimodal input processing for a virtual agent, the method comprising obtaining a multimodal input by the virtual agent from a user. The virtual agent employs an Artificial Intelligence (AI) model. The method may further include identifying a plurality of principal entities within the multimodal input. The method may further include extracting information about each entity of the plurality of principal entities. The method may also include generating a response based on the extracted information.

According to some example embodiments, the AI model is a Generative AI model.

According to some example embodiments, the method further comprises storing the extracted information within an associated database in each cycle of input processing.

According to some example embodiments, the multimodal input comprises data from modalities comprising sensors, ensembled data, speech, text, and vision.

According to some example embodiments, the method further comprises dynamically adapting user's accustomed communication style based on historical interactions of the virtual agent with the user.

According to some example embodiments, the AI model employs a role-based approach following user-provided instructions and prompts.

According to some example embodiments, the AI model is trained to understand and respond to user emotions conveyed through the multimodal input.

According to some example embodiments, the method further comprises continuously monitoring user engagement and satisfaction during interactions.

According to some example embodiments, the principal entities are selected from a group of a name, a date, a time, a numeric value, an address, a location, a sentiment, an emotional cue, a facial feature, a visual cue, a gesture, a body language, a parameter, an object, a command, and a keyword.

Some example embodiments disclosed herein provide a computer system for multimodal input processing for a virtual agent, the computer system comprises one or more computer processors, one or more computer readable memories, one or more computer readable storage devices, and program instructions stored on the one or more computer readable storage devices for execution by the one or more computer processors via the one or more computer readable memories, the program instructions comprising obtaining a multimodal input by the virtual agent from a user. The virtual agent employs an Artificial Intelligence (AI) model. The one or more processors are further configured for identifying a plurality of principal entities within the multimodal input. The one or more processors are further configured for extracting information about each entity of the plurality of principal entities. The one or more processors are further configured for generating a response based on the extracted information.

Some example embodiments disclosed herein provide a non-transitory computer readable medium having stored thereon computer executable instruction which when executed by one or more processors, cause the one or more processors to carry out operations for multimodal input processing for a virtual agent. The operations comprising obtaining a multimodal input by the virtual agent from a user. The virtual agent employs an Artificial Intelligence (AI) model. The operations further comprising identifying a plurality of principal entities within the multimodal input. The operations further comprising extracting information about each entity of the plurality of principal entities. The operations further comprising generating a response based on the extracted information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present disclosure will become apparent upon consideration of the following detailed description of embodiments thereof, especially when taken in conjunction with the accompanying drawings, and wherein:

FIG. 1 illustrates a use case of a user interaction with a virtual agent, in accordance with an example embodiment;

FIG. 2 illustrates a block diagram of an electronic circuitry for multimodal input processing for a virtual agent, in accordance with an example embodiment;

FIG. 3 shows a flow diagram of a method for multimodal input processing for a virtual agent, in accordance with an example embodiment;

FIG. 4 illustrates a block diagram for multimodal input processing for a virtual agent, in accordance with an example embodiment;

FIG. 5 shows a flow diagram of a method for multimodal input processing for a virtual agent, in accordance with another example embodiment;

FIG. 6 illustrates a flow diagram for multimodal input processing for a virtual agent, in accordance with another example embodiment;

FIG. 7 shows a flow diagram of a method for multimodal input processing for a virtual agent, in accordance with another example embodiment; and

FIG. 8 shows a flow diagram of a method for multimodal input processing for a virtual agent, in accordance with yet another example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The term “machine learning model” may be used to refer to a computational or statistical or mathematical model that is trained on classical ML modelling techniques with or without classical image processing. The “machine learning model” is trained over a set of data and using an algorithm that it may use to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

The term “virtual agent” may be used to refer to a virtual assistant that is computer program or AI system designed to simulate human-like conversations with users. They are typically powered by artificial intelligence and natural language processing technologies. The virtual agent can understand user inputs, generate appropriate responses, and perform specific tasks or provide information. They are often used in customer support, information retrieval, and other applications to provide automated and efficient conversational experiences.

### End of Definitions

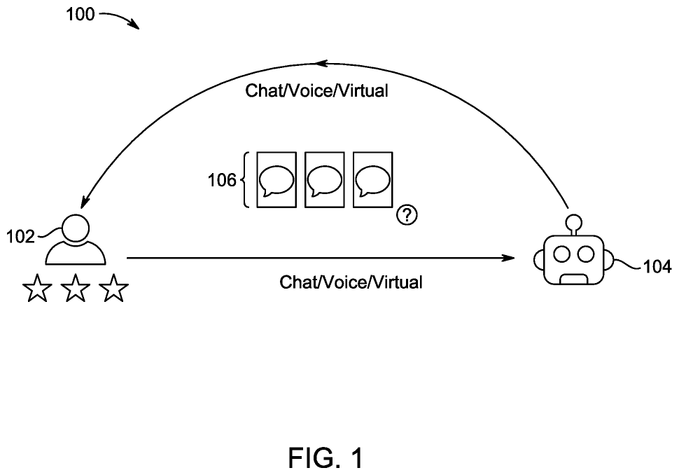

Embodiments of the present disclosure may provide a method, a system, and a computer program product for multimodal input processing for a virtual agent. The method, the system, and the computer program product for multimodal input processing for a virtual agent are described with reference to FIG. 1 to FIG. 8 as detailed below.

FIG. 1 illustrates a use case 100 of a user 102 interaction with a virtual agent 104, in accordance with an example embodiment. In an embodiment the interaction begins when the user 102 provides input to the virtual agent 104 through a medium 106. The user 102 may be, for example, a customer, client, or any other person seeking information or assistance through the virtual agent 104. The medium 106 is a conduit through which the user 102 and the virtual agent 104 exchange information. The medium 106 may take various forms, depending on the context of the interaction.

In some embodiments, the medium 106 may support multimodal communication, allowing the user 102 to combine various forms, such as text, speech, and visual of the user 102.

In some embodiments, the medium 106 may involve sensor data, such as data from accelerometers, gyroscopes, GPS sensor, or other environmental sensors (e.g., temperature and humidity sensor). This data may be used to convey information to the virtual agent 104 (especially in case of IoT, smart device, wearable device, or health monitoring device).

The user input may represent a query, request, or command from the user 102, indicating their intention or information they seek. The user input serves as the starting point for the virtual agent 104 to understand the user's needs and provide appropriate assistance or information. It ranges from specific questions or requests to more general inquiries or tasks. The objective of the virtual agent 104 is to accurately interpret and process the user input to deliver a relevant and helpful response.

In some embodiments, the user 102 may be a human that may provide query to virtual agent 104. In such scenario, the user 102 may interact with the virtual agent 104 configured to efficiently process and respond to user queries. The virtual agent 104 is equipped with advanced artificial intelligence (AI) models (for example, Generative AI model), allowing it to understand and address a wide range of user inputs, whether they are in the form of text, speech, or visual data. The virtual agent 104 offers an intuitive and user-friendly interface for human users, enhancing their overall experience and providing valuable assistance.

In some embodiments, the user 102 may also be another virtual entity, such as a computer-based agent, configured to interact with the virtual agent 104. These virtual entities are designed to communicate and collaborate seamlessly with the virtual agent 104, enabling a rich exchange of information and tasks. Whether the user 102 is a human or a virtual agent, the virtual agent 104 adaptability and ability to process multimodal inputs make it a versatile and powerful tool for a wide range of applications.

Depending on the capabilities of the virtual agent 104, it may support multiple inputs (e.g., text, voice, and visual) and techniques designed to accommodate the diverse nature of these inputs. These techniques may include but are not limited to:

Multimodal Input Processing: The virtual agent 104 is equipped to handle inputs from various modalities, such as text, voice, and visual data. It employs complex multimodal processing techniques to interpret and integrate these inputs effectively.

Speech Recognition: In cases where the user provides voice input, the virtual agent 104 may utilize speech recognition technology to convert spoken words into text for analysis and response generation.

Natural Language Processing (NLP): Text-based inputs are processed using NLP techniques, allowing the virtual agent 104 to understand the context, intent, and sentiment conveyed in the user's messages.

Computer Vision: When dealing with visual inputs, the virtual agent 104 leverages computer vision algorithms to analyze images or video feeds. This enables it to extract information from visual cues and provide contextually relevant responses.

Sensor Data Integration: In scenarios involving sensor data, such as data from IoT devices or wearables, the virtual agent 104 incorporates sensor data processing techniques. It may extract valuable information from sensor readings to respond appropriately to user queries or commands.

Multimodal Fusion: The virtual agent 104 excels at fusing information from multiple modalities. For example, it may combine text, voice, and visual data to gain a holistic understanding of the user's input and generate comprehensive responses.

Emotion Recognition: To enhance user-agent interactions, the virtual agent 104 may incorporate emotion recognition capabilities. This allows it to detect and respond to the emotional cues expressed by the user 102, adopting more concerned and tailored responses.

Personalization: Depending on the user's historical interactions and preferences, the virtual agent 104 may personalize its responses. It may adapt its communication style, tone, and content to align with the user's individual characteristics and preferences.

Continuous Learning: The virtual agent 104 may employ machine learning and historical data analysis to continuously improve its performance. By learning from past interactions, it may refine its responses and adapt to evolving user needs.

The multimodal processing techniques refer to methods and approaches employed by the virtual agent 104 to effectively handle and integrate information from multiple input modalities, such as text, voice, sensor data, and visual data. These techniques are crucial for creating a complete understanding of user interactions and generating contextually relevant responses.

These techniques collectively enable the virtual agent 104 to provide a sophisticated and versatile user experience, accommodating a wide range of input modalities and ensuring that users may interact with the agent in the most natural and effective way possible.

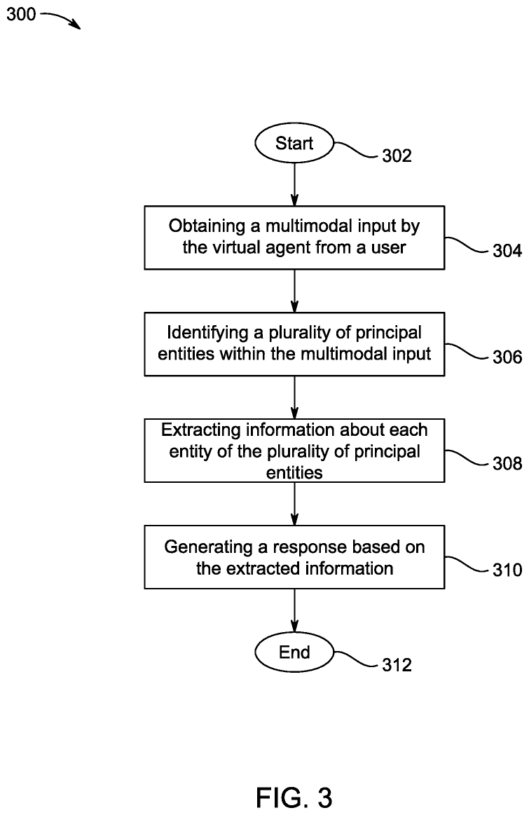

By accurately processing the multimodal inputs, the virtual agent 104 may extract information related to user emotions, expressions, eyes, speech, etc., to generate a meaningful response. This is further explained in greater detail in conjunction with FIGS. 3-8.

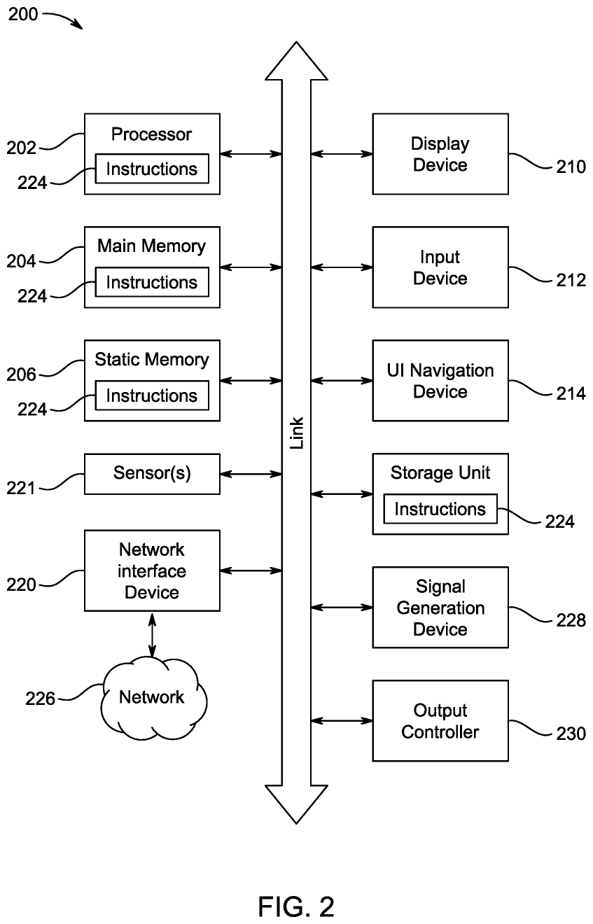

FIG. 2 illustrates a block diagram of an electronic circuitry for multimodal input processing for a virtual agent. The machine of FIG. 2 is shown as a standalone device, which is suitable for implementation of the concepts above. For the server aspects described above a plurality of such machines operating in a data centre, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 200 includes at least one processor 202 (e.g., a central processing unit (CPU), a graphics processing unit (GPU), advanced processing unit (APU), or combinations thereof), one or more memories such as a main memory 204, a static memory 206, or other types of memory, which communicate with each other via link 208. Link 208 may be a bus or other type of connection channel. The machine 200 may include further optional aspects such as a graphics display unit 210 comprising any type of display. The machine 200 may also include other optional aspects such as an alphanumeric input device 212 (e.g., a keyboard, touch screen, and so forth), a user interface (UI) navigation device 214 (e.g., a mouse, trackball, touch device, and so forth), a storage unit 216 (e.g., disk drive or other storage device(s)), a signal generation device 218 (e.g., a speaker), sensor(s) 221 (e.g., global positioning sensor, accelerometer(s), microphone(s), camera(s), and so forth), output controller 228 (e.g., wired or wireless connection to connect and/or communicate with one or more other devices such as a universal serial bus (USB), near field communication (NFC), infrared (IR), serial/parallel bus, etc.), and a network interface device 220 (e.g., wired and/or wireless) to connect to and/or communicate over one or more networks 226.

Executable Instructions and Machine-Storage Medium: The various memories (i.e., 204, 206, and/or memory of the processor(s) 202) and/or storage unit 216 may store one or more sets of instructions and data structures (e.g., software) 224 embodying or utilized by any one or more of the methodologies or functions described herein. These instructions, when executed by processor(s) 202 cause various operations to implement the disclosed embodiments.

### Example Machine Architecture and Machine-Readable Medium

FIG. 2 illustrates a representative machine architecture suitable for implementing the systems and so forth or for executing the methods disclosed herein. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

### Signal Medium

The term “signal medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

As used herein, the term “network” may refer to a long-term cellular network (such as GSM (Global System for Mobile Communication) network, LTE (Long-Term Evolution) network or a CDMA (Code Division Multiple Access) network) or a short-term network (such as Bluetooth network, Wi-Fi network, NFC (near-field communication) network, LoRaWAN, ZIGBEE or Wired networks (like LAN, el all) etc.).

As used herein, the term “computing device” may refer to a mobile phone, a personal digital assistance (PDA), a tablet, a laptop, a computer, VR Headset, Smart Glasses, projector, or any such capable device.

As used herein, the term ‘electronic circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

FIG. 3 shows a flow diagram of a method 300 for multimodal input processing for a virtual agent, in accordance with an example embodiment. It will be understood that each block of the flow diagram of the method 300 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 300 illustrated by the flowchart diagram of FIG. 3 shows the multimodal input processing for the virtual agent. Fewer, more, or different steps may be provided.

The method 300 starts at step 302, where the virtual agent is ready to process the user input. At step 304, the virtual agent obtains multimodal input from the user. The user input is versatile, accommodating a range of communication modalities, including spoken words (such as voice), text messages (such as conversation), visual cues (such as facial expressions), and data from various sensors. The virtual agent may employ an Artificial Intelligence (AI) model, which may, in particular embodiments, be a Generative AI (GenAI) model. The GenAI model represents a cutting-edge approach to artificial intelligence and is capable of multifaceted operations.

In specific implementations, the GenAI model may include, but not limited to, a Language model (LLM) for text, a Vision Language model (VLM) for vision-text, a speech model for speech, and other relevant modules. This comprehensive GenAI model is designed to process and respond to multimodal inputs effectively, making it exceptionally versatile in understanding and interacting with users across different modalities such as text, vision, and speech. In some embodiments, the GenAI model may take the form of an ensemble model allowing for even greater adaptability and proficiency in handling diverse inputs and user interactions.

In some embodiments, the multimodal user input may originate from diverse sources, including sensors and external data. These sources may encompass data from sensors like heart rate monitors, accelerometers, gyroscopes, GPS sensors, temperature, and humidity sensors, and even data obtained through API calls from the internet related to various services. The addition of data from these modalities improves the interaction and enhances the virtual agent capacity to address a wide array of user needs.

Once the multimodal input is obtained, further at 306, a plurality of principal entities within the multimodal input may be identified. The principal entities may include, but are not limited to, a name, a date, a time, a numeric value, an address, a location, a sentiment, an emotional cue, a facial feature, a visual cue, a gesture, a body language, a parameter, an object, a command, and a keyword. Identifying these entities is essential for understanding the user's input comprehensively.

Following entity identification, at step 308, the processing method 300 may further include extraction of detailed information about each entity of the plurality of principal entities. This information extraction process ensures that the virtual agent may access and utilize specific data related to the user input. It provides the foundation for generating contextually relevant and meaningful responses.

To further elaborate, consider an exemplary scenario of the user who initiates an interaction with the virtual agent by saying, “I've been feeling really sad lately, and I don't know how to cope with it.”

In this emotional query, several entities may be identified based on the content of the user input. Entities are specific pieces of information or elements within the user input that are relevant and meaningful for understanding the query comprehensively.

In this example, the principal entities within the query may include:

Emotion (sentiment entity): The user expresses sadness, which is a specific emotion they are feeling.

Duration (Time Entity): The query implies that the user has been feeling sad “lately,” indicating a time duration during which the emotion has been experienced.

Coping (Action Entity): The user mentions not knowing how to cope, indicating a desire for guidance or advice on coping strategies.

Following the identification of these principal entities, the detailed information about each of them may be extracted. Information extraction involves capturing relevant data associated with each entity that is necessary for understanding the query and generating a meaningful response.

The extracted information corresponding to the sentiment entity is the specific emotion mentioned by the user, which is “sadness.” This information helps the virtual agent understand the user's emotional state.

Further, the extracted information corresponding to the duration is “lately.” It indicates that the user has been experiencing sadness recently, which provides context for the virtual agent.

Additionally, the extracted information corresponding to action entity is the user's expression of not knowing how to cope with their emotions. This information highlights the user's need for guidance and support.

By extracting these information, the virtual agent gains a comprehensive understanding of the user's emotional query. The extracted information serves as the foundation for generating a response that is sensitive to the user's emotions, acknowledges their feelings, and provides guidance or support tailored to their specific situation.

Based on extracted information, the virtual agent proceeds to generate response at step 310. This response is designed to address the user query or input effectively. It may encompass various modalities, including text, voice, and visual elements, depending on the nature of the interaction and the user preferences. The method 300 terminates at 312. The virtual agent is now equipped to engage with the user, utilizing the extracted information and the capabilities of the AI model to provide a personalized and informed interaction.

The versatility of multimodal input processing unlocks the door to various practical applications. For example, it may be applied in scenarios such as jogging or running, where the virtual agent may assist with fitness tracking and navigation. In exploration scenarios, users who find themselves lost may receive guidance and support through this processing approach. Additionally, in weather-related applications like predicting rainfall, the virtual agent may guide users to take appropriate actions, such as returning home or seeking shelter.

In some example embodiments, a computer programmable product may be provided. The computer programmable product may comprise at least one non-transitory computer-readable storage medium having stored thereon computer-executable program code instructions that when executed by a computer, cause the computer to execute the method 500.

In an example embodiment, an apparatus for performing the method 300 of FIG. 3 above may comprise a processor (e.g., the processor 202) configured to perform some or each of the operations of the method 300. The processor may, for example, be configured to perform the operations 302-312 by performing hardware implemented logical functions, executing stored instructions, or executing algorithms for performing each of the operations.

Alternatively, the apparatus may comprise means for performing each of the operations described above. In this regard, according to an example embodiment, examples of means for performing operations (302-312) may comprise, for example, the processor 202 which may be implemented in the system 200 and/or a device or circuit for executing instructions or executing an algorithm for processing information as described above.

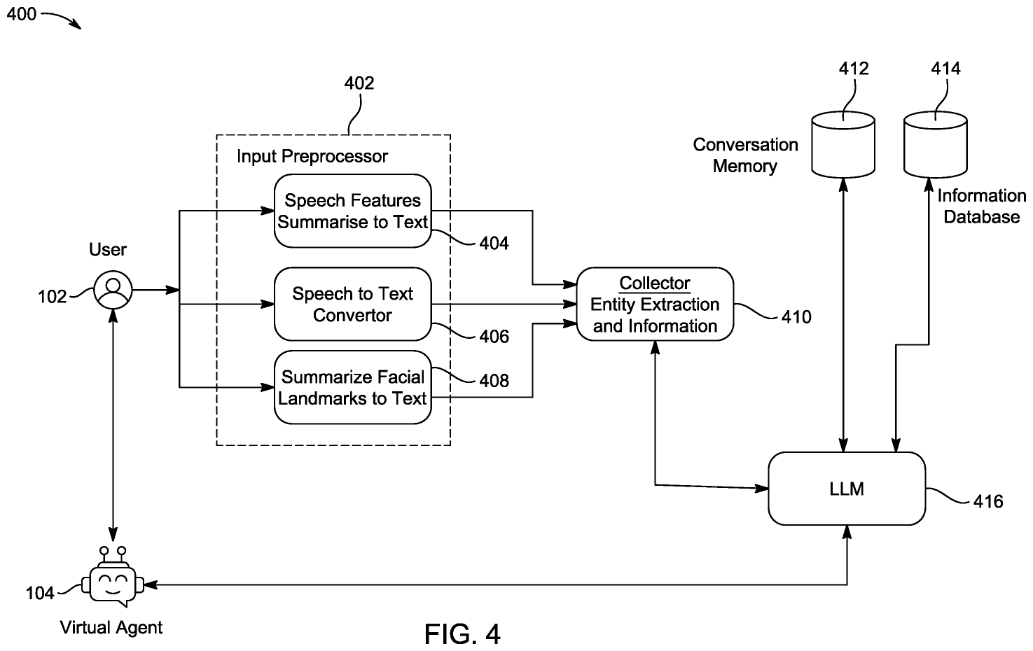

FIG. 4 illustrates a block diagram 400 for multimodal input processing for a virtual agent, consistent with embodiments of the present disclosure. The user 102 initiates the interaction by presenting a query or input in a multimodal form. This may include spoken words (voice), text messages (text), and visual (facial expression), all of which are sent to the virtual agent 104.

The user query may include a wide range of topics, including but not limited to:

Information Seeking: Users may seek answers to factual questions, such as inquiries about current events, historical facts, or general knowledge.

Emotional Expression: Users may express their emotions, sharing feelings of happiness, sadness, frustration, or excitement. These expressions may be accompanied by text, voice, and facial cues.

Advice and Guidance: Users may seek advice or guidance on personal or professional matters, such as relationship advice, career decisions, or lifestyle choices.

Task Execution: Queries may involve task-oriented requests, such as setting reminders, sending messages, or performing specific actions within the virtual agent's capabilities.

Entertainment: Users may engage in light-hearted or entertaining conversations, requesting jokes, riddles, or engaging in storytelling.

The multimodal nature of user query ensures that the virtual agent 104 may accommodate a wide array of communication styles and user preferences, making the interaction not only efficient but also personalized and engaging. This flexibility enables the virtual agent 104 to provide a diverse user needs and advance meaningful interactions across various domains and scenarios.

The process begins with an input preprocessor 402, which plays an important role in preparing the multimodal input for further analysis. Within the input preprocessor 402, three essential tasks are carried out:

Speech Features Summarized to Text 404: For voice inputs, speech features are summarized and converted into text form. This step involves the extraction of relevant information from the spoken input, ensuring that voice-based queries are translated into a textual format that can be processed by subsequent components.

Speech-to-Text Converter 406: Simultaneously, the input preprocessor employs a speech-to-text converter to transcribe the spoken words into text. This conversion enables the virtual agent to analyze and understand the textual representation of the voice input.

Summarization of Facial Landmarks to Text 408: In cases involving visual input or facial expressions, facial landmarks are summarized and converted into textual data. This allows the system to extract meaningful information from visual cues provided by the user.

The processed inputs from the input preprocessor 402, including text-based input, transcribed speech, and summarized facial landmarks, are passed to a collector 410. In particular, the collector 410 is a vital component within virtual agent architecture, responsible for handling the initial processing of user input. Its primary function is to observe, identify, and extract relevant entities and information from the user's multimodal input, which may include text, voice, and visual data.

The collector 410 scans the incoming multimodal input to identify and recognize specific entities or elements of interest. These entities may encompass a wide range of information, including names, dates, times, numeric values, addresses, locations, sentiments, emotions, facial features, visual cues, gestures, body language, parameters, objects, commands, and keywords. The collector entity recognition process ensures that all relevant aspects of the user input are acknowledged.

Once entities are identified, the collector 410 extracts detailed information associated with each entity. This information may include descriptive attributes, values, or characteristics relevant to the recognized entities. For example, if the user mentions a date, the collector may extract the specific date value. If the user expresses an emotion, the collector may extract the emotional state described.

The extracted entities and associated information are organized and structured within the collector 410. This data organization is critical for preparing the information for further analysis and reasoning by the virtual agent 104. It ensures that the collected data is easily accessible and interpretable for subsequent processing stages.

Depending on the user input and the nature of the conversation, the collector 410 dynamically adapts its entity recognition and information extraction processes. It remains flexible to handle diverse inputs, ensuring that the virtual agent 104 may respond effectively to a wide range of user queries and expressions.

The collector 410 acts as an intermediary between the multimodal input and the LLM 416 integrated within the virtual agent 104. It provides the LLM 416 with the extracted entities and information, enabling the LLM 416 to utilize this data for reasoning and response generation. It should be noted that the multimodal input processing may be enhanced by utilizing either a single model, or an ensemble of models designed to specific modalities, such as text, voice, and visual inputs. These models play an important role in converting the multimodal inputs into a standardized format before presenting them to the collector 410 for entity recognition and extraction.

Two critical sources of information are provided to the LLM 416 for its reasoning process: conversation memory 412 and information database 414.

The conversation memory 412 stores relevant information within the current interaction cycle. It allows the virtual agent 104 to maintain context and recall information during the ongoing conversation.

The information database 414 includes related information from private or public database that includes the references needed to answer the question, customized by the memory (conversation).

Finally, the LLM 416 processes the input, extracts relevant information from the memory 412 and database 414, and generates a multimodal response. This response aligns with the user's initial query, incorporating text, voice, and visual components, providing a seamless and comprehensive interaction experience.

For the sake of explanation, consider a scenario in which interaction begins when the user 102 initiates a conversation with the virtual agent 104 through a multimodal medium 106. In this scenario, the user query is emotional in nature and expressed using multiple modalities.

The user provides a complex query that includes:

Voice or Text: The user may speak or type the message, expressing their emotional state and concerns through the tone and pitch of their voice. For example, the user may speak or type, “I've been feeling really down lately, and I don't know what to do.”

Visual: The user's facial expression may exhibit signs of distress, such as a frowning or somber expression, and their eye movements may indicate introspection or sadness.

The multimodal input undergoes initial preprocessing within the input preprocessor 402. Here is what happens during this phase:

Speech Features Summarized to Text 404: The tone and pitch of the user's voice are transcribed into text form to make them accessible for further analysis.

Speech-to-Text Converter 406: The speech-to-text converter processes the user's voice inputs/input and converts it into textual data.

Summarize Facial Landmarks to Text 408: Visual cues, such as facial expressions and eye movements, are summarized and translated into textual descriptions for analysis.

The pre-processed multimodal data is then directed to the collector 410. In this scenario, the collector plays a critical role in understanding the user's emotional state and concerns:

Entity Identification: The collector 410 identifies key entities such as “user,” “emotions,” “speech,” “facial expression,” “eye movements,” and “concerns” from the user's input.

Information Extraction: It extracts detailed information related to these entities, recognizing the user's emotional state as “feeling really down” and their expressed concerns.

Data Organization: The collected entities and information are organized and structured within the collector 410, providing a foundation for further analysis.

The processed and organized data from the collector 410 is seamlessly integrated with the Large Language Model (LLM) 416. This integration enables the LLM 416 to utilize the collected information for reasoning and response generation.

Therefore, for this, the LLM 416 accesses two critical sources of information:

Conversation Memory 412: This memory stores relevant information within the current interaction cycle, allowing the virtual agent 104 to maintain context and recall information during the ongoing conversation.

Information Database 414: The information database contains references and data needed to answer the user's emotional query. It is customized by the conversation's context.

Based on the user's emotional input, the LLM 416 generates a multimodal response. This response aligns with the user's emotional state and concerns, providing empathetic and supportive feedback in a multimodal form, which may include text, voice, and visual components. The response aims to address the user's emotions and guide them toward positive steps.

In this scenario, the virtual agent effectively processes the user's emotional query, leveraging multimodal input and the capabilities of the LLM 416 to provide a contextually relevant and empathetic response.

The generated response (Multimodal) by the virtual agent 104 may be “I am genuinely sorry to hear that you have been feeling down lately. Acknowledging your emotions is an important first step. It is completely natural to feel this way sometimes. Additionally, the virtual agent 104 may provide guidance and support by saying “seeking support from friends, family, or a mental health professional can be immensely beneficial. Sharing your feelings with someone you trust can provide comfort and understanding. Additionally, consider engaging in activities that bring you joy and relaxation. Small steps towards self-care can make a big difference.”

It should be noted that while answering the query, the virtual agent's tone may be gentle and empathetic, facial expression reflects empathy, perhaps with a soft and understanding gaze, and eye movements may convey attentiveness and empathy, such as maintaining eye contact and nodding.

This generated response demonstrates the virtual agent's ability to address the user's emotional state with empathy and provide guidance and support. It acknowledges the user's feelings, offers reassurance, and encourages seeking help when needed. The multimodal response encompasses text, voice, and visual elements, making the interaction more engaging and empathetic, which is particularly valuable when dealing with emotional queries.

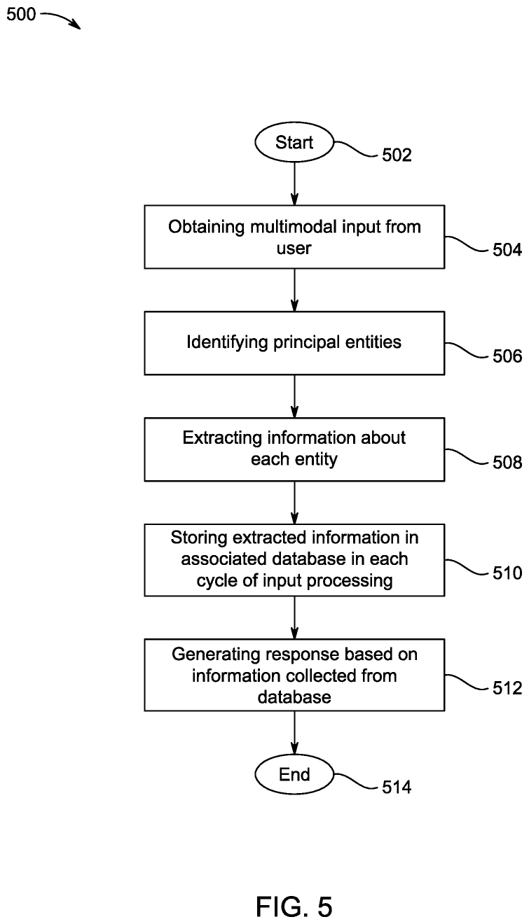

FIG. 5 illustrates a method 500 for multimodal input processing for a virtual agent, in accordance with another example embodiment. It will be understood that each block of the flow diagram of method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 500 illustrated by the flow diagram of FIG. 500 for multimodal input processing start at 502. The method 500 may include, at step 504, obtaining multimodal input by the virtual agent from a user. The multimodal input includes data from modalities comprising sensors, ensembled data, speech, text, and vision. The virtual agent may employ an Artificial Intelligence (AI) model. In some embodiments, the AI model may be a Generative AI (GenAI) model. Examples of the GenAI may include, but are not limited to, LLM, VLM, and the like. In some embodiments, the Gen AI may be an ensembled model,

Once the multimodal input is obtained, further the method 500 may include, at step 506, identifying a plurality of principal entities within the multimodal input. The principal entities may include, but are not limited to, a name, a date, a time, a numeric value, an address, a location, a sentiment, an emotional cue, a facial feature, a visual cue, a gesture, a body language, a parameter, an object, a command, and a keyword. Identifying these entities is essential for understanding the user's input comprehensively.

Further, the method 500, at step 508, may include extracting information about each entity of the plurality of principal entities. This is already explained in conjunction to FIG. 3.

Subsequently, at step 510, the method 500 includes storing the extracted information in an associated database in each cycle of input processing. This database serves as a repository for the collected data, enabling the virtual agent to maintain context and recall information during the ongoing interaction. Storing extracted information is crucial for maintaining continuity and providing context-aware responses.

Furthermore, at step 512 the method 500 may include generating response based on information collected from the database. The response generation is primarily based on the data extracted from the user input and stored in the database, ensuring that the responses are adapted to the user's query and context. The method 500 may be terminated, at step 514.

In some example embodiments, a computer programmable product may be provided. The computer programmable product may comprise at least one non-transitory computer-readable storage medium having stored thereon computer-executable program code instructions that when executed by a computer, cause the computer to execute the method 500.

In an example embodiment, an apparatus for performing the method 500 of FIG. 5 above may comprise a processor (e.g., the processor 202) configured to perform some or each of the operations of the method 500. The processor may, for example, be configured to perform the operations 502-514 by performing hardware implemented logical functions, executing stored instructions, or executing algorithms for performing each of the operations. Alternatively, the apparatus may comprise means for performing each of the operations described above. In this regard, according to an example embodiment, examples of means for performing operations (502-514) may comprise, for example, the processor 202 which may be implemented in the system 200 and/or a device or circuit for executing instructions or executing an algorithm for processing information as described above.

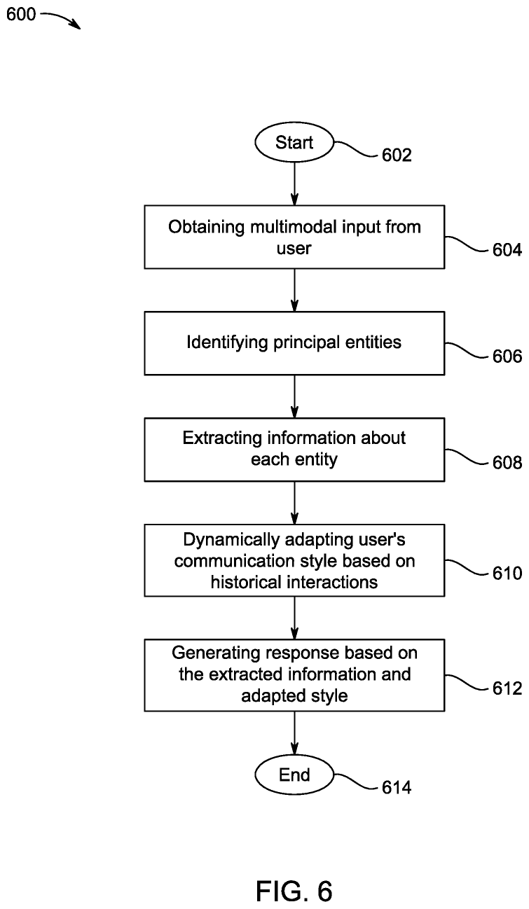

FIG. 6 shows a flow diagram of a method 600 for multimodal input processing for a virtual agent, in accordance with another example embodiment. It will be understood that each block of the flow diagram of the method 600 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600 illustrated by the flowchart diagram of FIG. 6 shows a method for multimodal input processing for a virtual agent. Fewer, more, or different steps may be provided.

The method 600 start at 602 and commence with creating obtaining multimodal input by the virtual agent from a user, at step 604. The multimodal input includes data from modalities comprising sensors, ensembled data, speech, text, and vision. The virtual agent may employ an Artificial Intelligence (AI) model. In some embodiments, the AI model may be a Large Language Model (LLM). The AI model operates using a role-based approach, following user-provided instructions and prompts.

Once the multimodal input is obtained, further the method 600 may include, at step 606, identifying a plurality of principal entities within the multimodal input. The principal entities may include, but are not limited to, a name, a date, a time, a numeric value, an address, a location, a sentiment, an emotional cue, a facial feature, a visual cue, a gesture, a body language, a parameter, an object, a command, and a keyword.

Further, the method 600, at step 608, may include extracting information about each entity of the plurality of principal entities. This is already explained in conjunction to FIG. 3.

Subsequently, at step 610, the method 600 includes dynamically adapting user's accustomed communication style based on historical interactions of the virtual agent with the user. This adaptation is aimed at enhancing the user's experience by aligning the virtual agent responses with the user's preferences and accustomed communication patterns. It should be noted that historical interaction between the user and the virtual agent may be stored in conversation memory.

This may be achieved by:

Historical Interaction Data: The virtual agent maintains a record of previous interactions and conversations with the user. This historical data includes not only the content of the conversations but also the user's communication style, tone, language preferences, and any specific instructions or prompts provided by the user during past interactions.

Analysis and Learning: The virtual agent uses machine learning and natural language processing techniques to analyze this historical interaction data. It identifies patterns, trends, and user preferences in terms of how the user prefers to communicate.

Dynamic Adaptation: Based on the understandings from historical data analysis, the virtual agent dynamically adjusts its communication style when interacting with the user.

This adaptation may encompass several aspects, including:

Tone and Style: The virtual agent may adjust its tone of speech, formality, or informality to match the user's preferences. For example, if the user tends to use a casual and friendly tone, the virtual agent may respond in a similarly friendly manner.

Language and Vocabulary: If the user has a preference for certain language nuances or specific vocabulary, the virtual agent incorporates these into its responses. It avoids jargon or terminology that the user may find unfamiliar.

Response Length: The virtual agent considers whether the user prefers concise and to-the-point responses or more detailed and explanatory answers. It may adjust response length accordingly.

Emotional Sensitivity: If the user frequently discusses emotional topics, the virtual agent may become more empathetic and sensitive in its responses, providing emotional support when needed.

Furthermore, at step 612 the method 600 may include generating response based on extracted information and the adapted style, and the method 600 may be terminated, at step 614.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, an apparatus for performing the method 600 of FIG. 6 above may comprise a processor (e.g., the processor 202) configured to perform some or each of the operations of the method 600. The processor may, for example, be configured to perform the operations (602-614) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (602-614) may comprise, for example, the processor 202 which may be implemented in the system 200 and/or a device or circuit for executing instructions or executing an algorithm for processing information as described above.

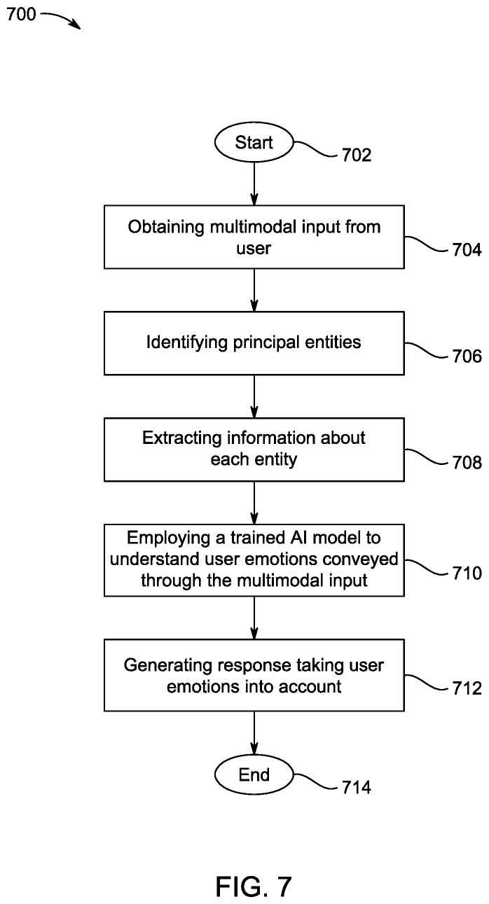

FIG. 7 illustrates a method 700 for multimodal input processing for a virtual agent, in accordance with another example embodiment. It will be understood that each block of the flow diagram of the method 700 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 700 illustrated by the flow diagram of FIG. 7 for multimodal input processing for a virtual agent starts at step 702. The method 700 may include, at step 704, obtaining multimodal input by the virtual agent from a user. The multimodal input includes data from modalities comprising sensors, ensembled data, speech, text, and vision. The virtual agent may employ an Artificial Intelligence (AI) model. In some embodiments, the AI model may be a Large Language Model (LLM). The AI model operates using a role-based approach, following user-provided instructions and prompts.

Once the multimodal input is obtained, further the method 700 may include, at step 706, identifying a plurality of principal entities within the multimodal input. The principal entities may include, but are not limited to, a name, a date, a time, a numeric value, an address, a location, a sentiment, an emotional cue, a facial feature, a visual cue, a gesture, a body language, a parameter, an object, a command, and a keyword.

Further, the method 700, at step 708, may include extracting information about each entity of the plurality of principal entities. This is already explained in conjunction to FIG. 3.

Subsequently, at step 710, the method 700 includes employing a trained AI model to understand user emotions conveyed through the multimodal input. It should be noted that the training of the AI model typically occurs during the AI model initial development and prior to its deployment for user interactions. The AI model is trained to understand user emotions conveyed through multimodal input. This training phase typically occurs during the AI model initial development and fine-tuning stages, ensuring that it may recognize and respond to user emotions effectively.

The training of AI model may be performed by the following steps:

AI Model Development: The AI model, which may be the LLM, is developed and trained in a controlled environment using large datasets that include examples of user interactions, emotions, and multimodal inputs. During this initial training phase, the model learns to recognize and understand various aspects of user emotions conveyed through text, speech, and visual cues.

Fine-Tuning: After the initial training, the AI model may undergo a fine-tuning process to specialize in recognizing and responding to user emotions. This fine-tuning involves providing the model with additional data and guidance specifically related to emotional cues and responses.

Deployment: Once the AI model is well-trained and fine-tuned, it is deployed for user interactions. This is where the steps described in the method (e.g., obtaining multimodal input, identifying principal entities, extracting information) come into play. The model uses its training to understand user emotions in real-time during interactions.

Once the AI model is trained and deployed, the method 700, at step 712 includes generating responses taking user emotions into account. This ensures that the virtual agent may respond with empathy and sensitivity when the user discusses emotional topics. The method 700 terminates at step 714.

In some example embodiments, a computer programmable product may be provided. The computer programmable product may comprise at least one non-transitory computer-readable storage medium having stored thereon computer-executable program code instructions that when executed by a computer, cause the computer to execute the method 700.

In an example embodiment, an apparatus for performing the method 700 of FIG. 7 above may comprise a processor (e.g., the processor 202) configured to perform some or each of the operations of the method 700. The processor may, for example, be configured to perform the operations (702-714) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (702-714) may comprise, for example, the processor 202 which may be implemented in the system 200 and/or a device or circuit for executing instructions or executing an algorithm for processing information as described above.

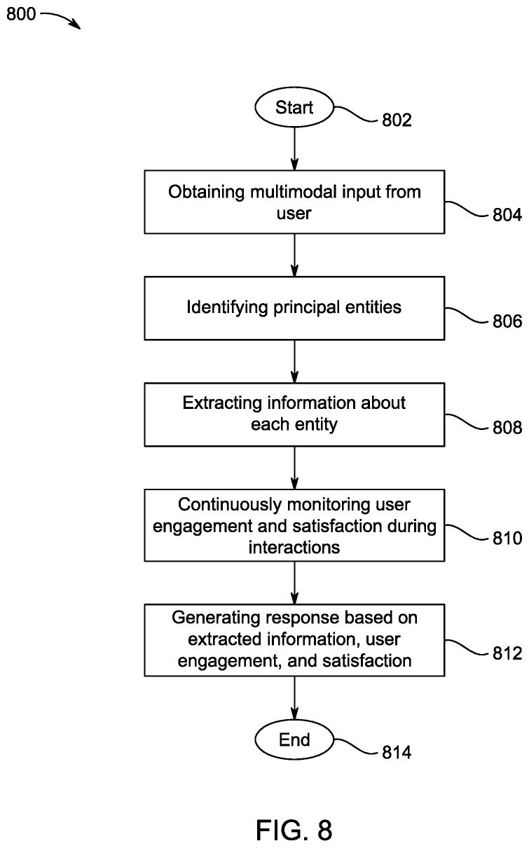

FIG. 8 illustrates a method 800 for multimodal input processing for a virtual agent, in accordance with yet another example embodiment. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 800 illustrated by the flow diagram of FIG. 8 for multimodal input processing for a virtual agent may start at step 802 and at step 804, the method 800 may include obtaining multimodal input by the virtual agent from a user. The multimodal input includes data from modalities comprising sensors, ensembled data, speech, text, and vision. The virtual agent may employ an Artificial Intelligence (AI) model. In some embodiments, the AI model may be a Large Language Model (LLM). The AI model operates using a role-based approach, following user-provided instructions and prompts.

Once the multimodal input is obtained, further the method 800 may include, at step 806, identifying a plurality of principal entities within the multimodal input. The principal entities may include, but are not limited to, a name, a date, a time, a numeric value, an address, a location, a sentiment, an emotional cue, a facial feature, a visual cue, a gesture, a body language, a parameter, an object, a command, and a keyword.

Further, the method 800, at step 808, may include extracting information about each entity of the plurality of principal entities. This is already explained in conjunction to FIG. 3.

Subsequently, at step 810, the method 800 includes continuously monitoring user engagement and satisfaction during interactions. This may be done by the following steps:

Real-Time Assessment: As the user interacts with the virtual agent, the system actively monitors various indicators of user engagement and satisfaction in real time. These indicators may include the user's response times, the frequency and depth of their interactions, their emotional cues (if visual data is available), and explicit feedback provided by the user.

Engagement Metrics: The system calculates engagement metrics based on the observed user behavior. For example, it may track how actively the user is participating in the conversation, whether they are asking follow-up questions, and whether they appear attentive and responsive.

Satisfaction Evaluation: Alongside engagement metrics, the system assesses user satisfaction. This evaluation may consider the user emotional state throughout the interaction, their feedback (if provided), and their overall experience.

Dynamic Adaptation: The continuous monitoring of user engagement and satisfaction serves as valuable feedback for the virtual agent. If the system detects a drop in engagement or signs of user dissatisfaction, it may dynamically adapt its responses and approach to re-engage the user and improve satisfaction.

Further, at step 812, the method 800 may include generating response based on extracted information, user engagement, and satisfaction. Thus, the responses are crafted not only by considering the information extracted from the user's input (as explained in step 808) but also by factoring in the user's engagement level and satisfaction. The method 800 terminates at step 814.

In some example embodiments, a computer programmable product may be provided. The computer programmable product may comprise at least one non-transitory computer-readable storage medium having stored thereon computer-executable program code instructions that when executed by a computer, cause the computer to execute the method 800.

In an example embodiment, an apparatus for performing the method 800 of FIG. 8 above may comprise a processor (e.g., the processor 202) configured to perform some or each of the operations of the method 800. The processor may, for example, be configured to perform the operations (802-814) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (802-814) may comprise, for example, the processor 202 which may be implemented in the system 200 and/or a device or circuit for executing instructions or executing an algorithm for processing information as described above.

As will be appreciated by those skilled in the art, the techniques described in the various embodiments discussed above are not routine, or conventional, or well understood in the art. The present disclosure addresses the limitations of existing techniques in multimodal input processing for a virtual agent. Unlike conventional approaches that often rely solely on text-based input, the disclosed techniques enable virtual agents to process multimodal inputs. Users may communicate through text, speech, and visual cues, making interactions more natural and accommodating diverse user preferences. By utilizing an LLM in conjunction with a role-based approach and continuous monitoring of user engagement and satisfaction, the disclosed techniques represent a novel and highly innovative approach to enhancing the capabilities of virtual agents.

The techniques discussed above provide advantages like enhanced user engagement, improved user satisfaction, and more personalized interactions with virtual agents. By incorporating multimodal input processing that encompasses text, speech, and visual cues, these techniques allow users to communicate with virtual agents in a more natural and intuitive manner, resulting in a richer and more immersive user experience. One of the key advantages is the ability to understand and respond to user emotions, which significantly enhances the virtual agent's capacity to provide empathetic and sensitive support. Users can freely express their emotions, and the virtual agent may adapt its responses, accordingly, offering comfort and assistance when needed. The techniques include training AI models to understand and respond to user emotions conveyed through multimodal inputs. This capability allows virtual agents to respond with empathy and sensitivity, particularly when users express emotional concerns or queries. Using LLMs for understanding user's query, these techniques enhance the accuracy of responses and the efficiency of virtual agents in providing relevant information. These techniques have wide-ranging applications, such as, healthcare, entertainment, financial advisor, and the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

What is claimed is:

1. A computer-implemented method for multimodal input processing for a virtual agent comprising:
obtaining a multimodal input by the virtual agent from a user, wherein the virtual agent employs an Artificial Intelligence (AI) model;
identifying a plurality of principal entities within the multimodal input;
extracting information about each entity of the plurality of principal entities; and
generating a response based on the extracted information.

2. The computer-implemented method of claim 1, wherein the AI model is a Generative AI model.

3. The computer-implemented method of claim 1, further comprising storing the extracted information within an associated database in each cycle of input processing.

4. The computer-implemented method of claim 1, wherein the multimodal input comprises data from modalities comprising sensors, ensembled data, speech, text, and vision.

5. The computer-implemented method of claim 1, further comprising dynamically adapting user's accustomed communication style based on historical interactions of the virtual agent with the user.

6. The computer-implemented method of claim 1, wherein the AI model employs a role-based approach following user-provided instructions and prompts.

7. The computer-implemented method of claim 1, wherein the AI model is trained to understand and respond to user emotions conveyed through the multimodal input.

8. The computer-implemented method of claim 1, further comprising continuously monitoring user engagement and satisfaction during interactions.

9. The computer-implemented method of claim 1, wherein the principal entities are selected from a group of a name, a date, a time, a numeric value, an address, a location, a sentiment, an emotional cue, a facial feature, a visual cue, a gesture, a body language, a parameter, an object, a command, and a keyword.

10. A computer system multimodal input processing for a virtual agent comprising, the computer system comprising: one or more computer processors, one or more computer readable memories, one or more computer readable storage devices, and program instructions stored on the one or more computer readable storage devices for execution by the one or more computer processors via the one or more computer readable memories, the program instructions comprising:
obtaining a multimodal input by the virtual agent from a user, wherein the virtual agent employs an Artificial Intelligence (AI) model;
identifying a plurality of principal entities within the multimodal input;
extracting information about each entity of the plurality of principal entities; and
generating a response based on the extracted information.

11. The system of claim 10, wherein the AI model is a Generative AI model.

12. The system of claim 10, wherein the program instructions further comprising storing the extracted information within an associated database in each cycle of input processing.

13. The system of claim 10, wherein the multimodal input comprises data from modalities comprising sensors, ensembled data, speech, text, and vision.

14. The system of claim 10, wherein the program instructions further comprising dynamically adapting user's accustomed communication style based on historical interactions of the virtual agent with the user.

15. The system of claim 10, wherein the AI model employs a role-based approach following user-provided instructions and prompts.

16. The system of claim 10, wherein the AI model is trained to understand and respond to user emotions conveyed through the multimodal input.

17. The system of claim 10, wherein the program instructions further comprising continuously monitoring user engagement and satisfaction during interactions.

18. The system of claim 10, wherein the principal entities are selected from a group of a name, a date, a time, a numeric value, an address, a location, a sentiment, an emotional cue, a facial feature, a visual cue, a gesture, a body language, a parameter, an object, a command, and a keyword.

19. A non-transitory computer-readable storage medium having stored thereon computer executable instruction which when executed by one or more processors, cause the one or more processors to carry out operations for multimodal input processing for a virtual agent, the operations comprising perform the operations comprising:
obtaining a multimodal input by the virtual agent from a user, wherein the virtual agent employs an Artificial Intelligence (AI) model;
identifying a plurality of principal entities within the multimodal input;
extracting information about each entity of the plurality of principal entities; and
generating a response based on the extracted information.
